(19) United States
(12) Patent Application Publication
(10) Pub. No.: US 2025/0105877 A1
(43) Pub. Date: Mar. 27, 2025

(54) Techniques for Communication of Capabilities in Wireless Charging Systems

(71) Applicant: Apple Inc., Cupertino, CA (US)

(72) Inventors: Jinqian Yu, Campbell, CA (US); Sherjeel Shehzad, Auckland (NZ); Gordon Y Scott, Cupertino, CA (US); Ho Cheung Chung, San Jose, CA (US); Nan Liu, Sunnyvale, CA (US); Selestino L Rodan, Auckland (NZ); Andrew C Chang, Sunnyvale, CA (US); William R Walitsch, Fremont, CA (US)

(21) Appl. No.: 18/501,852

(22) Filed: Nov. 3, 2023

Related U.S. Application Data
(60) Provisional application No. 63/584,799, filed on Sep. 22, 2023.

(51) Int. Cl. H04B 5/00; H02J 50/10

(52) U.S. Cl. CPC H04B 5/79; H02J 50/10

(57) ABSTRACT

An electronic device may transmit a self-identification message indicating its capabilities as a wireless power transmitter to nearby devices.

This application claims the benefit of U.S. provisional patent application No. 63/584,799, filed Sep. 22, 2023, which is hereby incorporated by reference herein in its entirety.

### FIELD

This relates generally to power systems and, more particularly, to wireless power systems for charging electronic devices.

### BACKGROUND

In a wireless charging system, a wireless power transmitting device transmits wireless power to a wireless power receiving device. The wireless power receiving device charges a battery and/or powers components using the wireless power. In some conditions, electromagnetic energy between a wireless power transmitter and receiver system can be received at nearby devices.

### SUMMARY

A wireless power transfer system is operable in proximity to a wireless communication device. The wireless power system includes a power transmitting device that transmits first wireless power signals to a power receiving device during a wireless power transfer session. The wireless communication device, when in proximity to the wireless power transfer system during the wireless power transfer session, can attempt to perform near-field data communication with the power transmitting device.

Control circuitry for the power transmitting device can periodically transmit an identification message indicative of the power transmitting device operating as a wireless power transfer device rather than a near-field data communication device. Control circuitry for the wireless communication device can forgo, based on the received identification message, performing near-field data communication with the power transmitting device, thereby improving coexistence by avoiding unnecessary actions in preparation for performing near-field data communication such as activating near-field communication circuitry and a user interface indicative of performing near-field data communication for an application, as examples.

### BRIEF DESCRIPTION OF THE DRAWINGS

FIG. 1 is a schematic diagram of an illustrative wireless power system in accordance with some embodiments.

FIG. 2 is a perspective view of an illustrative wireless power system having a wireless power transmitting tablet computer and an associated wireless power receiving computer stylus in accordance with some embodiments.

FIG. 3 is a side view of an illustrative wireless power system operable in close proximity to a wireless communication device in accordance with some embodiments.

FIG. 4 is a schematic diagram of an illustrative wireless communication device in accordance with some embodiments.

FIG. 5 is a timing diagram showing how an illustrative wireless power transmitting device may transmit a self-identification message during a wireless power transfer session in accordance with some embodiments.

FIG. 6 is a flowchart of illustrative operations for operating a wireless power transmitting device in accordance with some embodiments.

FIG. 7 is a flowchart of illustrative operations for operating a wireless communication device in close proximity to a wireless power transfer system in accordance with some embodiments.

### DETAILED DESCRIPTION

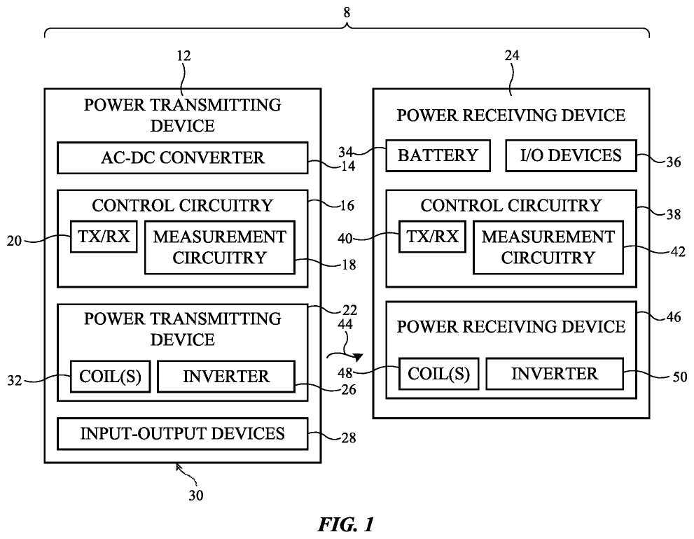

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24. sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer-readable storage media (e.g., tangible computer-readable storage media) in the control circuitry of WPT system 8. The software code may sometimes be referred to as software, data, program instructions, instructions, or code. The non-transitory computer-readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer-readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment. Illustrative configurations in which PTX device 12 is an electronic device such as a tablet computer are described herein as an example.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment. Illustrative configurations in which PRX device 24 is a peripheral user input device or generally an accessory for PTX device 12 such as a computer stylus are described herein as an example.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter 14 that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transfer coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding coils such as wireless power receiving coil(s) 48 in PRX device 24. In other words, one or more of coils 32 are inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding (alternating-) currents are induced in coil(s) 48. The AC signals 44 that are used in transmitting wireless power may have any suitable frequency, such as 128 kHz, 326 kHz, 360 kHz, 105-210 kHz, 100-400 kHz, 1-100 MHz, 1-20 MHz, 13.56 MHz etc. In some configurations, the power transmission frequency may be determined by communications between devices 12 and 24. In other configurations, the power transmission frequency may be fixed.

Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32 or wireless power transmitting coils 32. Coils 48 are sometimes referred to herein as wireless power transfer coils 48 or wireless power receiving coils 48.

The DC voltage produced by rectifier circuitry 50 (sometimes referred to as rectifier output voltage Vrect) can be used in charging a battery such as battery 34 and can be used in powering other components in PRX device 24 such as control circuitry 38, input-output (I/O) devices 36, etc. PTX device 12 may also include input-output devices such as input-output devices 28. Input-output devices 36 and/or input-output devices 28 may include input devices for gathering user input and/or making environmental measurements and may include output devices for providing a user with output.

As examples, input-output devices 28 and/or input-output devices 36 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 36 may also include sensors for gathering input from a user and/or for making measurements of the surroundings of WPT system 8. In the example described herein in which PTX device 12 is a tablet computer and PRX device 24 is a computer stylus, input-output devices 28 include a touch-sensitive and/or force-sensitive display that displays images and that detects PRX device 24 coming into contact with and/or pressing against the display.

The example in FIG. 1 of PRX device 24 including battery 34 is merely illustrative. If desired, an electronic device may include a supercapacitor to store charge instead of a battery. For example, PRX device 24 may include a supercapacitor in place of battery 34. Battery 34 may therefore sometimes be referred to as power storage device 34 or supercapacitor 34.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. Wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. Implementations using in-band communication also may utilize load modulation for communication. For example, the NFC near-field communication standard specifies techniques for wireless power transfer and wireless data communication at 13.56 MHz. Implementations using out-of-band communication may utilize, for example, hardware antenna structures and communication protocols such as Bluetooth to communicate out-of-band data between PTX device 12 and PRX device 24. Power may continue to be conveyed wirelessly during out-of-band data transmissions. Implementation using out-of-band communication can also employ the NFC standard protocol for data communication, as set forth by the NFC Forum. Wireless transceiver circuitry 20 may wirelessly transmit and/or receive out-of-band signals to and/or from PRX device 24 using an antenna of device 12 (e.g., separate from coil 32).

Control circuitry 16 in PTX device 12 has measurement circuitry 18 that may be used to perform measurements of one or more characteristics external to PTX device 12. For example, measurement circuitry 18 may detect external objects on or adjacent the charging surface of the housing of PTX device 12. The charging surface may be formed by a planar outer surface of an upper housing wall or a peripheral sidewall of device 12 or may have other shapes (e.g., concave or convex shapes, etc.). While shown in FIG. 1 as being separate from power transmitting circuitry 22 for the sake of clarity, measurement circuitry 18 may form a part of power transmitting circuitry 22 if desired.

Measurement circuitry 18 can detect foreign objects such as coils, paper clips, and other metallic objects, can detect the presence of PRX device 24 (e.g., circuitry 18 can detect the presence of one or more coils 48 and/or magnetic core material associated with coils 48), and/or can detect the presence of other power transmitting devices in the vicinity of PTX device 12 and/or WPT system 8. Measurement circuitry 18 can also be used to make sensor measurements using a capacitive sensor, can be used to make temperature measurements, and/or can otherwise be used in gathering information indicative of whether a foreign object, power transmitting device, power receiving device, or other external object (e.g., PRX device 24) is present on or adjacent to the coil(s) 32 of PTX device 12. If desired, PRX device 24 may include measurement circuitry 42. Measurement circuitry 42 may perform one or more of the measurements performed by measurement circuitry 18 (e.g., for or using coil(s) 48 on PRX device 24).

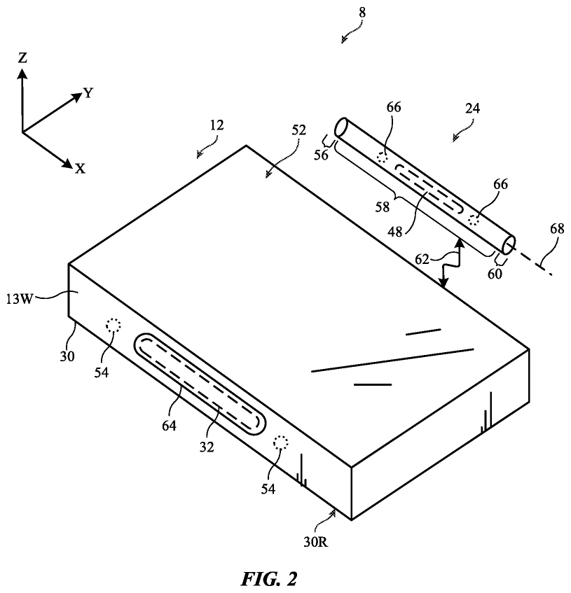

FIG. 2 is a perspective view showing how PRX device 24 can interact with PTX device 12 in an illustrative configuration where PTX device 12 is a tablet computer or other device with a touch screen and PRX device 24 is a computer stylus or another type of accessory device to PTX device 12. The computer stylus may be paired with the tablet computer. A user can use the computer stylus (e.g., PRX device 24) to draw or write on the tablet computer (e.g., PTX device 12) and to provide other input to the tablet computer.

As shown in FIG. 2, PTX device 12 includes a housing such as housing 30. PTX device 12 also includes a display 52 mounted to housing 30. Display 52 may be a capacitive touch screen display or a display that includes other types of touch sensor technology. The touch sensor of display 52 may be configured to receive input from a computer stylus (e.g., PRX device 24). If desired, display 52 may also be sensitive to force (e.g., may generate a force sensor input indicative of how hard PRX device 24 is pressing against display 52).

Display 52 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

PRX device 24 may have a cylindrical shape or other elongated body that extends along longitudinal axis 68. Wireless transceiver circuitry 20 in PTX device 12 and wireless transceiver circuitry 40 in PRX device 24 (FIG. 1) may support wireless communications via wireless communications link 62 (e.g., a Bluetooth link). As an example, PRX device 24 may supply wireless input to PTX device 12 via link 62 (e.g., information on settings in a drawing program or other software running on PTX device 12, input to select a desired on-screen option, input to supply PTX device 12 with a touch gesture such as a stylus flick, input to draw a line or other object on display 52, input to move or otherwise manipulate images displayed on display 52, etc.).

PRX device 24 may have a tip portion such as tip 56. Tip 56 may contain a conductive elastomeric member that is detected by the capacitive touch sensor of display 52. If desired, tip 56 may contain active electronics (e.g., circuitry that transmits signals that are capacitively coupled into the touch sensor of display 52 and that are detected as touch input on the touch sensor).

Shaft portion 58 of PRX device 24 may couple tip 56 of PRX device 24 to the opposing end 60 of PRX device 24. End 60 may contain a conductive elastomeric member, active electronics (e.g., circuitry that transmits signals that are capacitively coupled into the touch sensor of display 52 and that are detected as touch input on the touch sensor), buttons, a metal connector that mates with an external plug, an antenna (e.g., for supporting link 62), and/or other input-output components.

PRX device 24 may include a metal tube or other conductive components in shaft portion 58. The body of PRX device 24 may be formed from metal and/or plastic tubes and other elongated structures. The metal tube or other structures in PRX device 24 may serve as an antenna ground for one or more antennas in PRX device 24. An antenna resonating element for the antenna may be formed from metal traces on a printed circuit or other dielectric support structure and/or from other conductive structures. An antenna resonating element may be located in end region 60, along shaft 58, in tip region 56, or in other suitable portions of PRX device 24. The antenna may be used to support wireless link 62. One or more wireless power receiving coils such as coil 48 may be disposed along shaft 58 overlapping a non-metallic region or other opening (e.g., through which coil 48 operates). Coil 48 may be covered by a dielectric outer tube or cover layer that forms the housing or exterior of PRX device 24. If desired, PRX device 24 may include one or more attachment structures such as magnets 66. Magnets 66 may help to secure PRX device 24 to a suitable portion of PTX device 12 during wireless power transfer (sometimes referred to herein as wireless charging).

Housing 30 of PTX device 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 30 may be formed using a unibody configuration in which some or all of housing 30 is machined or molded as a single structure or may be formed using multiple structures (e.g., an internal frame structure, one or more structures that form exterior housing surfaces, etc.). In the example of FIG. 2, housing 30 includes a peripheral conductive sidewalls 30W that surround the lateral periphery of PTX device 12 and display 52. Housing 30 may, if desired, include a conductive rear wall 30R that opposes display 52 (e.g., conductive rear wall 30R may form the rear exterior face, side, or surface of PTX device 12). If desired, rear wall 30R and sidewalls 30W may be formed from a continuous metal structure (e.g., in a unibody configuration) or from separate metal structures. Openings may be formed in housing 30 to form communications ports, holes for buttons, and other structures if desired. In another suitable arrangement, rear wall 30R and/or sidewalls 30W may be formed from dielectric materials such as ceramics, plastic, or glass.

Display 52 may be protected using a display cover layer such as a layer of transparent glass, clear plastic, transparent ceramic, sapphire, or other transparent crystalline material, or other optically transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of PTX device 12 (e.g., extending across an entirety of a length dimension of PTX device 12 parallel to the X-axis and a width dimension of PTX device 12 parallel to the Y-axis of FIG. 2). Sidewalls 30W may extend from a rear face of PTX device 12 formed by rear wall 30R to the display cover layer (e.g., extending across a height dimension of PTX device 12 parallel to the Z-axis of FIG. 2). In another suitable arrangement, the display cover layer may cover substantially all of the front face of PTX device 12 or only a portion of the front face of PTX device 12. Openings may be formed in the display cover layer. For example, an opening may be formed in the display cover layer to accommodate a button, speaker, fingerprint sensor, etc. One or more antennas for supporting wireless communications link 62 may be mounted within housing 30.

Housing 30 may have four peripheral edges (e.g., conductive sidewalls 30W). One or more wireless power transmitting coils such as coil 32 may be mounted within housing 30, behind display 52, and adjacent to a housing sidewall 30W such as at a location overlapping region 64 of FIG. 2. In scenarios where housing sidewalls 30W are formed from conductive material, a dielectric window may be formed within the sidewalls (e.g., region 64 may form a dielectric window in sidewall 30W for coil 32). Coil 32 is mounted behind the dielectric window to allow wireless power to be transferred to PRX device 24 when PRX device 24 is placed adjacent to the dielectric window. If desired, PTX device 12 may include one or more attachment structures such as magnets 54 located along, adjacent, or overlapping region 64. Magnets 54 and/or magnets 66 can help to secure PRX device 24 in place against region 64 of sidewall 30W during wireless charging (e.g., in a position/orientation at which the coil 32 in PTX device 12 is sufficiently aligned with the coil 48 in PRX device 24 so as to maximize wireless power transfer efficiency).

In this example, when it is desired to charge PRX device 24, a user places PRX device 24 against sidewall 30W (e.g., with longitudinal axis 68 of PRX device 24 extending parallel to the X-axis of FIG. 2). Magnets 54 and/or 66 may snap PRX device 24 against sidewall 30W and may hold PRX device 24 in place (e.g., at an optimal position/orientation for maximizing wireless power transfer efficiency). When PRX device 24 is placed adjacent or against region 64, coil 32 on PTX device 12 is aligned with the coil 48 on PRX device 24. Coil 32 then transmits wireless power (e.g., wireless power signals 44 of FIG. 1) to coil 48 for powering or charging PRX device 24.

This example is illustrative and non-limiting. In general, coil 32 may be disposed at any desired location within PTX device 12. For example, coil 32 may be disposed within PTX device 12 at a location overlapping display 52 (e.g., for charging PRX device 24 through an inactive region of display 52 while the PRX device rests on the inactive region), at a location overlapping other sidewalls 30W of PTX device 12, and/or at a location overlapping rear wall 30R (e.g., for charging PRX device 24 through a dielectric portion or window of rear wall 30R while the PRX device rests on rear wall 30R). If desired, PTX device 12 may include multiple coils 32 at different locations within PTX device 12. If desired, two or more coils 32 in PTX device 12 may be at least partially overlapping with respect to each other within the same region of PTX device 12.

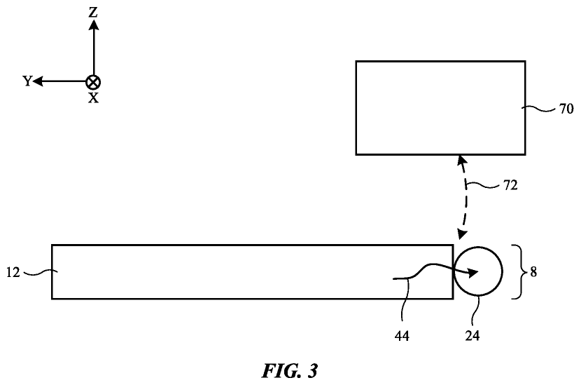

During operation, situations may arise in which a given WPT system 8 comes into proximity with other external equipment such as a wireless communication device. FIG. 3 is a side view (e.g., as viewed in the +X direction of FIG. 2) showing one such situation. As shown in FIG. 3, an illustrative WPT system 8 may include PTX device 12 (e.g., a tablet computer) and PRX device 24 (e.g., a computer stylus that is paired with the tablet computer). External equipment such as wireless communication device 70 may be located and operate in close proximity to WPT system 8 (e.g., within 10 mm, within 75 mm, within 100 mm, etc., such as when PTX device 12 is resting on an underlying surface of a desktop or tabletop and wireless communication device 70 has been placed on top of or is moved over PTX device 12). Wireless communication device 70, in some examples, is a smart phone or wristwatch device having NFC capabilities.

As shown in FIG. 3, a user (e.g., the user of WPT system 8 and/or wireless communication device 70) mounts PRX device 24 to (against) the sidewall 30W of PTX device 12 (e.g., overlapping region 64 of FIG. 2). Magnets 54 and/or 66 or other alignment and/or attachment structures help to hold PRX device 24 in place against the sidewall 30W of PTX device 12. PTX device 12 transmits wireless power signals 44 to PRX device 24 through sidewall 30W while PRX device 24 is mounted to sidewall 30W. Power receiving circuitry 46 (FIG. 1) on PRX device 24 charges battery 34 and/or powers the components of PRX device 24 using wireless power signals 44.

While PTX device 12 transmits wireless power signals 44 to PRX device 24, a user (e.g., the same user of WPT system 8 or a different user) may move device 70 over or generally in close proximity to WPT system 8 (e.g., within 100 mm of WPT system 8). When device 70 is in close proximity to WPT system 8, the transmission of wireless power signals 44 can cause undesired interactions with device 70. For example, as shown by arrow 72, at least some of the electromagnetic (field) energy associated with wireless power signals 44 can be detected by wireless communication device 70 (e.g., by a coil or other antenna in wireless communication device 70).

In particular, wireless power signals 44 may be conveyed at one or more frequencies that coincide with one or more frequencies at which wireless communication circuitry on device 70 operates. In some configurations described herein as an illustrative example, wireless power signals 44 may be conveyed at a frequency of approximately 13.56 MHz (e.g., at a frequency band centered at 13.56 MHz and with an appropriate bandwidth in compliance with the NFC standard set by the NFC Forum). The wireless communication circuitry of device 70 may include near-field communication circuitry that operates at or near the same frequency (band) as wireless power signals 44.

As described herein, the phrases “near-field data communication” and “near-field communication” refer to communication generally between wireless systems within a particular range, such as between antennas that transmit and receive electromagnetic signals within the near-field regime, whereas NFC (Near-Field Communication) refers to an illustrative implementation of near-field (data) communication such as when near-field (data) communication is implemented in a manner compatible or complaint with the NFC standard set by the NFC Forum.

Continuing with the illustrative example described above, after detecting the electromagnetic (field) energy associated with wireless power signals 44, wireless communication device 70 may supply power to near-field communication circuitry (or generally activate near-field communication circuitry) and/or perform other actions thereon in an attempt to perform near-field data communication with PTX device 12. As an illustrative example, corresponding control circuitry on device 70 may activate an application or more specifically a user interface for the application to facilitate a near-field data communication interaction with PTX device 12. Configurations in which the application is a transit application or mobile payment application and the user interface is usable to facilitate entry and/or points-of-sale are sometimes described herein as an illustrative example. If desired, other applications may be prompted by the presence of the detected electromagnetic field.

However, this interaction between WPT system 8 and wireless communication device 70 may not be desired as PTX device 12 is operating in its capacity as a wireless power transmitting device rather than as a near-field data communication device. In other words, whereas the above-mentioned interaction should normally take place based on wireless communication device 70 detecting an electromagnetic field caused by a near-field data communication device such as a door entrance reader, e-ticket terminal, point-of-sale (POS) terminal or another device with which device 70 should preemptively prepare appropriate near-field data communication facilitated interactions (e.g., present a user interface for the appropriate near-field data communication device), this interaction may be inappropriate when detecting the electromagnetic field caused by WPT system 8.

Accordingly, to promote coexistence between wireless communication device 70 and WPT system 8, it may be desirable for WPT system 8 to indicate to device 70 that PTX device 12 is not operating as a near-field data communication device and/or is operating as a wireless power transmitting device. Illustrative details for PTX device 12 sending an indication of its identity as a wireless power transmitting device to device 70 and/or device 70 processing the received indication are described herein.

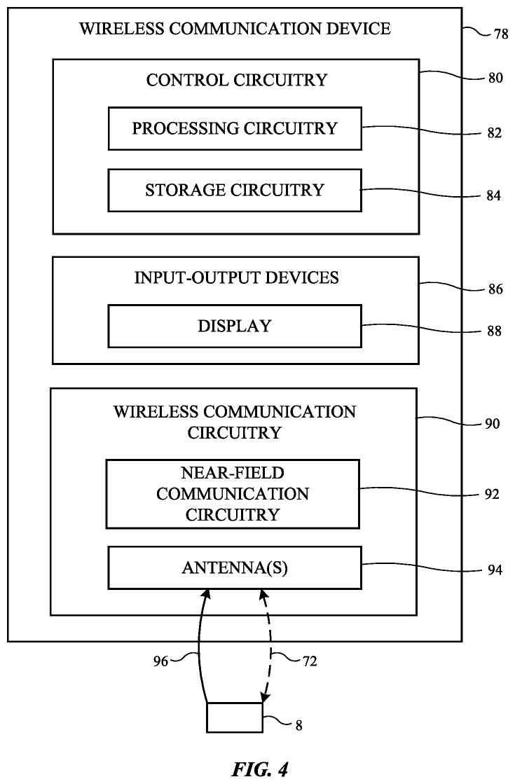

FIG. 4 shows an illustrative wireless communication device 78. In an illustrative situation described herein as an example, wireless communication device 78 in FIG. 4 may be placed or generally operate in close proximity to a WPT system (e.g., may be an implementation of device 70 in FIG. 3 operable in proximity to WPT system 8). In other instances, device 70 (FIG. 3) may be a device implemented in other manners (different than device 78 in FIG. 4).

Wireless communication device 78 may include components located on or within an electronic device housing. Wireless communication device 78 may include control circuitry 80. Control circuitry 80 may include storage circuitry 84 including nonvolatile and volatile memory. Control circuitry 80 may include processing circuitry 82 used to control the operation of device 78. Processing circuitry 82 may include one or more microprocessors, microcontrollers, digital signal processors, host processors, baseband processor integrated circuits, application specific integrated circuits, central processing units (CPUs), etc. Control circuitry 80 may be configured to perform operations in device 78 using hardware (e.g., dedicated hardware or circuitry), firmware, and/or software. Software code for performing operations in device 78 may be stored on storage circuitry 84 (e.g., storage circuitry 84 may include non-transitory (tangible) computer-readable storage media that stores the software code). The software code may sometimes be referred to as program instructions, software, data, instructions, or code. Software code stored on storage circuitry 84 may be executed by processing circuitry 82. Control circuitry 80 may be used to run software on device 78 such as applications.

Device 78 may include input-output devices 86 such as a touchscreen (display) 88 and one or more buttons. Control circuitry 80 implements communication protocols such as NFC, Bluetooth, WiFi, cellular, and so forth. Wireless communication circuitry 90 may support wireless communications (e.g., based on one or more protocols implemented by control circuitry 80). Wireless communication circuitry 90 may include one or more antennas 94 (e.g., a conductive coil for near-field communication). Wireless communication circuitry 90 (sometimes referred to as wireless circuitry 90) may also include baseband processor circuitry or other processor circuitry, transceiver circuitry, amplifier circuitry, filter circuitry, switching circuitry, radio-frequency transmission lines, and/or any other circuitry for transmitting and/or receiving radio-frequency signals using antenna(s) 94.

Wireless communication device 78 may be implemented as a computing device such as a laptop computer, a desktop computer, a computer monitor containing an embedded computer, a tablet computer, a cellular telephone, a media player, or other handheld or portable electronic device, a wearable device such as a wristwatch device, a pendant device, a headphone or earpiece device, a device embedded in eyeglasses or other equipment worn on a user's head, or other wearable or miniature device, a television, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

Configurations in which wireless communication circuitry 90 includes circuitry for supporting near-field communication are described herein as an illustrative example. Support for near-field communication could include compliance or compatibility with the NFC standard set forth by the NFC Forum. Other types of near-field communications are also possible. Near-field communication circuitry 92 may include baseband processor circuitry or other processor circuitry, transceiver circuitry, amplifier circuitry, filter circuitry, switching circuitry, radio-frequency transmission lines, and/or any other circuitry for transmitting and/or receiving radio-frequency signals using a near-field coil (antenna) for supporting near-field communication.

Wireless communication circuitry 90 may transmit and/or receive radio-frequency signals within corresponding radio-frequency bands. As an example, near-field communication circuitry 92 may convey (e.g., transmit and/or receive) radio-frequency signals with one or more frequency bands associated with near-field communication such as a near-field communication frequency band centered at 13.56 MHz. Additionally, the frequency bands handled by wireless circuitry 90 (e.g., by non-near-field communication circuitry therein) may include wireless local area network frequency bands (e.g., Wi-Fi), GPS, cellular, and so forth.

In the situation described in connection with FIG. 3 (e.g., when device 78 is placed in proximity to WPT system 8 as device 70 in FIG. 3), near-field communication circuitry 92 of device 78, using antenna 94 (e.g., a coil), may detect an electromagnetic field (sometimes referred to as electromagnetic energy as coupled onto a corresponding coil or antenna) associated with wireless power signals 44 as indicated by arrow 72. In particular, near-field communication circuitry 92 may detect the electromagnetic energy as part of a field detection operation using a corresponding antenna 94. Based on the detected electromagnetic field, control circuitry 80 may wake additional circuitry, such as supplying near-field communication circuitry 92 with power and/or otherwise activating near-field communication circuitry 92 in preparation for near-field data communication with the source of the detected electromagnetic field. However, because system 8 is a wireless power transfer system and more specifically PTX device 12 (FIG. 3) in system 8 is operating as a wireless power transmitting device, there is no intended near-field data communication between wireless communication device 78 and PTX device 12. Consequently, device 78 may activate and continually supply power to near-field communication circuitry 92 (and take other actions) in preparation for near-field data communication that does not actually occur (e.g., that is not intended to occur given that PTX device 12 is operating as a wireless power transmitting device). These actions can increase power consumption of device 78. Additionally, in situations where device 78 displays a corresponding user interface or activates software applications related to near-field communications, responsive to the detected electromagnetic field, a user of device 78 may be confused about the seemingly inappropriate execution of the application and/or user interface.

To improve coexistence between device 78 (or generally device 70 in FIG. 3) and WPT system 8, WPT system 8 (e.g., PTX device 12) may convey an indication (e.g., in the form of message 96) of PTX device 12 operating as a wireless power transmitter. Wireless communication circuitry 90, using antenna 94, (e.g., antenna 94 for near-field communication circuitry 92 or another antenna for non-near-field communication circuitry such as Bluetooth communication circuitry or Wi-Fi communication circuitry) may receive message 96 containing an operational identity and/or a wireless power transmission function of PTX device 12.

In response to receiving and processing message 96 with wireless communication circuitry 90, control circuitry 80 of device 78 may forgo one or more actions normally taken in preparation for near-field data communication (e.g., in response to detecting the electromagnetic field of wireless power signals 44). In such a manner, wireless communication device 78 need not supply power to near-field communication circuitry 92 or otherwise activate near-field communication circuitry 92 and need not present irrelevant application and/or user interface information when operating in close proximity to WPT system 8. Accordingly, coexistence between wireless communication device 78 and WPT system 8 is enhanced.

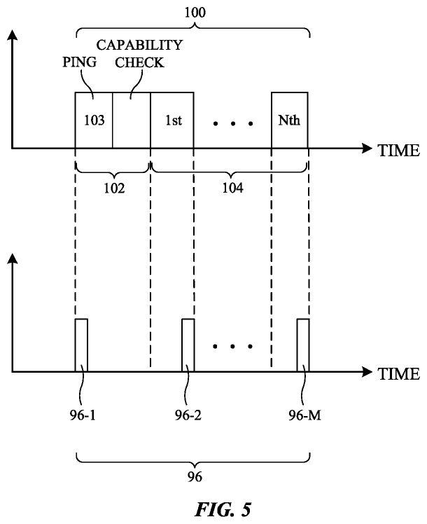

FIG. 5 is an illustrative timing diagram showing an illustrative manner in which an identification message 96 may be transmitted by PTX device 12 for a wireless power transfer session performed between PTX device 12 and PRX device 24. Identification message 96 is sometimes referred to as a self-identification message when containing identifying information for the sending device.

The top graph of FIG. 5 shows how a wireless power session, such as session 100, may include signaling between PTX device 12 and PRX device 24 that are associated with various functional capabilities of the devices. The bottom graph of FIG. 5 shows the timing of transmission of identification message 96 relative to the various periods that are illustrated in the top graph.

Exemplary wireless charging session 100 includes a ping phase (time period) 103 during which PTX device 12 assesses whether a potential PRX device 24 is proximate. If a potential PRX device 24 is proximate, PTX device 12 performs a handshake 102 with PRX device 24 to assess parameters for wireless power transfer. During handshake 102, PTX device 12 and PRX device 24 may signal capabilities such as protocols and supported charging speeds. An exemplary charging standard is the Wireless Charging Specification of the NFC standard.

After handshake 102, PTX device 12 may transmit wireless power signals 44 to PRX device 24 over a number of charging cycles (e.g., a first cycle, a second cycle, . . . , an Nth cycle) during charging time period 104. During each charging cycle, PTX device 12 and/or PRX device 24 may perform closed-loop communication therebetween to adjust various charging parameters. For example, PRX device 24 may indicate the amount of power received and PTX device 12 may adjust its output accordingly.

During the above-described activities of wireless power transfer session 100, PTX device 12 may periodically transmit self-identification messages 96 (e.g., as shown in the bottom graph of FIG. 5). Message 96 may be an identification message indicative of PTX device 12 operating as a wireless power transfer device, rather than a near-field data communication device. Accordingly, when external equipment such as wireless communication device 70 (e.g., device 78 in FIG. 4) operating in close proximity to PTX device 12 receives message 96, device 70 may take actions to suppress attempts to perform near-field data communication with PTX device 12 even when device 70 detects the electromagnetic energy of wireless power signals 44. Message 96, which may be sent in the form of a data packet, can include information generally identifying a class of intended receiving devices (e.g., devices operating as near-field data communication devices, devices operating as wireless power transfer devices, etc.), information specifically identifying PTX device 12 as operating in a wireless power transmission mode of operation out of other possible modes of operation in which PTX device 12 is operable (including a near-field data communication mode of operation), and/or other information indicative of the currently operating identity or function of the PTX device 12.

In the example of FIG. 5, PTX device 12 transmits a first instance 96-1 of identification message 96 during the object detection ping time period 103. It should be noted that PTX device 12 may transmit self-identification messages during other time periods in session 100. For example, during the handshake (time period) 102, PTX device 12 may also transmit self-identification message(s) 96 in addition to digital ping signals. Conceptually, it may be advantageous to transmit self-identification messages during time periods where the relevant near-field communication protocol permits custom (sometimes called extended or vendor-specific) data packets. The transmission of message 96 alerts nearby external equipment to the presence of PTX device 12 acting as a wireless power transmitting device.

In the example of FIG. 5, PTX device 12 may additionally transmit or broadcast additional instances 96-2 . . . 96-M of message 96 during wireless power transfer session 100 such as at an end of each of the wireless power transfer cycles collectively spanning the closed-loop charging time period 104. In particular, between an end of a first wireless power transfer cycle and a beginning of a subsequent second wireless power transfer cycle, PTX device 12 may send a synchronization message to PRX device 24 to synchronize wireless charging operations between cycles. Before the sending of the synchronization message (e.g., at the end of the first wireless power transfer cycle), PTX device 12 may transmit instance 96-2 of message 96 to continue indicating its operation as a wireless power transmitting device. In a similar manner, PTX device 12 may continue to transmit instances 96-M of message 96, each at an end of a corresponding wireless power transfer cycle of the charging operation during time period 104. If desired, messages other than the synchronization message (e.g., a dummy read message or another customized message) may be conveyed from PTX device 12 to PRX device 24 between adjacent wireless charging cycles and instances 96-2 . . . 96-M of message 96 may similarly be transmitted before these other dummy or customized messages. If PTX device 12 includes out-of-band data transmission circuitry in addition to wireless charging circuitry, it can additionally or alternatively transmit self-identification message(s) 96 using signals that are out-of-band relative to the wireless power transfer signals.

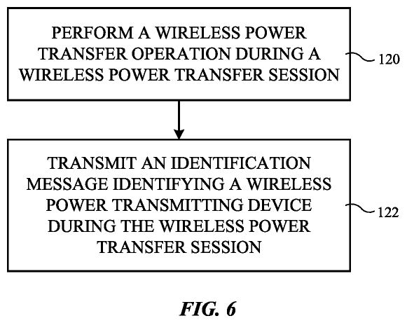

FIG. 6 is a flowchart of illustrative operations that are performed by a PTX device 12 (FIG. 1) of a WPT system 8 to improve coexistence during wireless power transfer. At block 120, control circuitry 16 (FIG. 1) may use wireless power transmitting circuitry 22 (FIG. 1) to perform a wireless power transfer operation during a wireless power transfer session, such as session 100 as discussed with reference to FIG. 5, with a corresponding PRX device 24 (FIG. 1).

At block 122, control circuitry 16 may use wireless power transmitting circuity 22 (e.g., coil 32 in an in-band communication implementation) or separate wireless communication circuitry (e.g., an antenna separate from coil 32 in an out-of-band communication implementation) to transmit an identification message (e.g., message 96 in FIG. 5) identifying PTX device 12 as a wireless power transmitting device during the wireless power transfer session. Control circuitry 16 may transmit the identification message at any suitable time with respect to the wireless power transfer session. In particular, control circuitry 16 may transmit message 96 periodically across the wireless power transfer session. As examples, at least some adjacent pairs of transmission for message 96 may be sent with a regular periodicity such as a periodicity on the order of hours such as 1 hour, 1 hour and 20 minutes, 2 hours, etc., a periodicity on the order of minutes such as 1 minute, 2 minutes, 3 minutes, 5 minutes, 10 minutes, 20 minutes, etc., a periodicity on the order of seconds such as 1 second, 15 seconds, 20 seconds, 30 seconds, etc., a periodicity on the order of (10s or 100s of) milliseconds such as 75milliseconds, 100 milliseconds, 250 milliseconds, etc., or any other suitable periodicity (e.g., any other periodicity between 10 milliseconds and 2 hours). If desired, some adjacent pairs of transmission for message 96 may be sent with an irregular periodicity. As one illustrative implementation, control circuitry 16 may transmit message 96 once at the beginning of the wireless power transfer session (e.g., as the first message transmitted for the wireless power transfer session, concurrently with the digital ping messages transmitted during handshake time period 102 in FIG. 5, etc.) and may periodically transmit message 96 during each wireless power transfer cycle during the closed-loop charging time period.

The transmission of the identification message throughout the wireless power transfer session allows the PTX device 12 to indicate its current operating identity as a wireless power transfer device to neighboring devices (e.g., device 70) that may attempt to perform near-field data communication with PTX device 12. If desired, in other situations (e.g., when PRX device 24 is decoupled from PTX device 12, when a near-field data communication application is executing on PTX device 12, etc.), device 12 may indicate its current operating identity as a near-field data communication device, e.g., to promote neighboring devices (e.g., device 70) to perform near-field data communication with device 12.

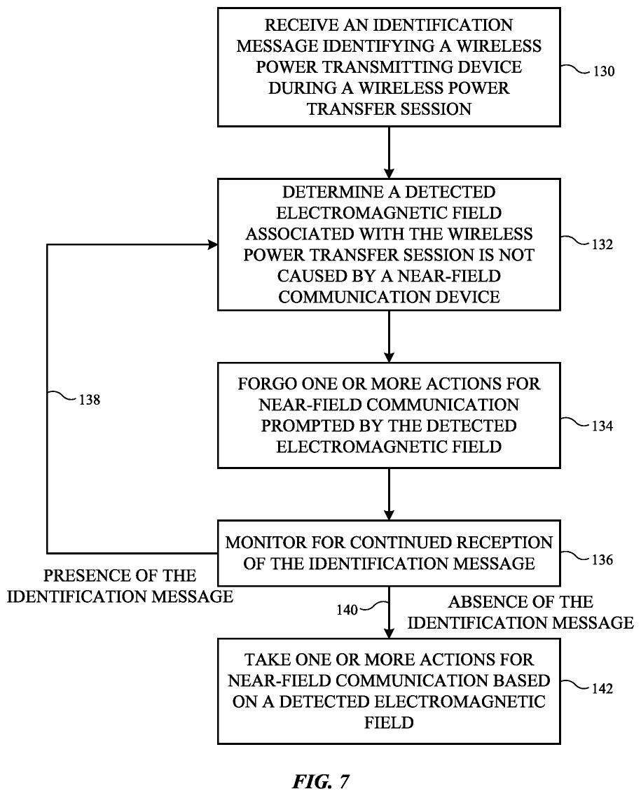

FIG. 7 is a flowchart of illustrative operations that are performed by a wireless communication device 70 (FIG. 3) operable in close proximity to a WPT system 8 to improve coexistence with WPT system 8 (FIG. 3). An illustrative scenario in which device 78 (FIG. 4) having control circuitry 80 and wireless communication circuitry 90 is an instance of device 70 in FIG. 3 and performs the operations described in connection with FIG. 7 is described below as an example. If desired, other types of device 70 may perform the operations described in connection with FIG. 7.

At block 130, wireless communication circuitry 90 of device 78 may receive, using an antenna (e.g., a near-field communication antenna 94 in an in-band communication implementation or a separate antenna 94 in an out-of-band communication implementation) an identification message (e.g., message 96 in FIG. 5) identifying PTX device 12 as a wireless power transmitting device during a wireless power transfer session (e.g., wireless power transfer session 100 in FIG. 5). In particular, the identification message may have information indicative of PTX device 12 operating as a wireless power transfer device and/or not a near-field data communication device.

Based on the received identification message (e.g., wireless communication circuitry 90 and/or control circuitry 80 processing the received identification message), control circuitry 80 may, at block 132, determine that a detected electromagnetic field (energy) associated with the wireless power signals for the wireless power transfer session is not caused by a near-field data communication device (e.g., not caused by a device currently operating as a near-field data communication device) but rather caused by a wireless power transfer device (e.g., caused by a device currently operating as a wireless power transfer device). In other words, control circuitry 80 may determine whether the received self-identification message is indicative of the wireless power transmitting device operating as a wireless power transfer device or as a near-field data communication device.

At block 134, control circuitry 80 of device 78 may forgo one or more actions in preparation for near-field data communication that would otherwise (without reception of the identification message at block 130) have been prompted by the detected electromagnetic field (energy). Put more explicitly, in one illustrative scenario, control circuitry 80 may, in accordance with a determination of the wireless power transmitting device operating as the near-field data communication device based on the identification message, perform near-field data communication with the near-field data communication device. In another illustrative scenario described herein sometimes as an example, control circuitry 80 may, in accordance with a determination of the wireless power transmitting device operating as a wireless power transfer device, forgo performing the near-field data communication with the wireless power transfer device (e.g., forgo actions in preparation for the near-field data communication). As examples, control circuitry 80 may forgo the activation of near-field communication circuitry 92 (e.g., reduce power supplied to near-field communication circuitry 92) and/or forgo the presentation of one or more user interfaces indicative of near-field data communication for an application such as a transit application, an e-ticket reader application, a mobile payment application, etc. at a display (e.g., touchscreen display 88 in FIG. 4).

At block 136, control circuitry 80 may monitor for continued reception of the identification message by wireless communication circuitry 90 (e.g., antenna 94). In particular, control circuitry 80 may expect to detect additional instances of the identification message as along as the wireless power transfer session remains active.

Accordingly, in the presence of additional instance(s) of the identification message (as received and processed), control circuitry 80 may proceed via path 138 back to block 132. Based on any additional instance of the identification message, control circuitry 80 may, at block 132, continue to determine that the electromagnetic field (energy) associated with the wireless power signals for the wireless power transfer session is not caused by a near-field data communication device and may, at block 134, continue to forgo the one or more actions for near-field data communication.

In the absence of any further instances of the identification message (being received and processed), control circuitry 80 may proceed via path 140 to a normal state of operation when handling near-field data communication. Accordingly, at block 142, control circuitry 80 may take one or more actions for near-field data communication (e.g., actions in preparation for the near-field data communication) based on a detected electromagnetic field (energy) which, in the absence of the identification message, may be indicative of the detected electromagnetic field (energy) being caused by an external near-field data communication device such as an e-ticket reader, a payment or point-of-sale terminal, etc.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent with.”

The foregoing description contemplates the use of self-identification messages to indicate whether, for example, an electronic device is acting as an NFC wireless power transmitter or an NFC data communication terminal. It is desirable for nearby NFC receivers to understand this information and initiate the most appropriate device functionality. It is noted that the present technology need not involve the transmission of personally identifiable information in order to function. For example, the self-identification message need not indicate ownership of the transmitting device in transmitting self-identification messages. Out of an abundance of caution, it is noted that to the extent that implementations of this wireless charging technology involve the use of personally identifiable information, implementers should follow privacy policies and practices that are generally recognized as meeting or exceeding industry or governmental requirements for maintaining the privacy of users.

The foregoing is merely illustrative and various modifications can be made to the described embodiments. The foregoing embodiments may be implemented individually or in any combination.

What is claimed is:

1. An electronic device comprising:
a wireless power transfer coil; and
control circuitry coupled with the wireless power transfer coil and configured to:
perform a wireless power transfer operation during a wireless power transfer session by transmitting a wireless power signal to a wireless power receiving device using the wireless power transfer coil; and
transmit an identification message indicative of an identity of the electronic device during the wireless power transfer session.

2. The electronic device of claim 1, wherein the identification message identifies the electronic device as a wireless power transmitting device.

3. The electronic device of claim 2, wherein the electronic device is operable in a wireless power transmission mode of operation and in a near-field data communication mode of operation and wherein the identification message identifies the electronic device as operating in the wireless power transmission mode of operation.

4. The electronic device of claim 2, wherein the control circuitry is configured to transmit, using the wireless power transfer coil, the identification message periodically during the wireless power transfer session.

5. The electronic device of claim 4, wherein transmitting the wireless power signal occurs during a closed-loop charging time period that includes a plurality of wireless power transfer cycles, and wherein the control circuitry is configured to transmit, using the wireless power transfer coil, the identification message during each of the wireless power transfer cycles.

6. The electronic device of claim 5, wherein the control circuitry is configured to transmit, using the wireless power transfer coil, the identification message at least once before the closed-loop charging time period during the wireless power transfer session.

7. The electronic device of claim 6, wherein messages are exchanged with the wireless power receiving device during a handshake time period before the closed-loop charging time period and wherein the control circuitry is configured to transmit, using the wireless power transfer coil, the identification message at a beginning of the handshake time period.

8. The electronic device of claim 7, wherein the exchange of messages during the handshake time period sets up the wireless power transfer session to be in compliance with a Near-Field Communication (NFC) standard.

9. The electronic device of claim 2 further comprising:
an antenna separate from the wireless power transfer coil, wherein the control circuitry is configured to transmit, using the antenna, the identification message periodically during the wireless power transfer session.

10. The electronic device of claim 9, wherein transmitting the wireless power signal occurs during a closed-loop charging time period that includes a plurality of wireless power transfer cycles and wherein the control circuitry is configured to transmit, using the antenna, the identification message during each of the wireless power transfer cycles.

11. The electronic device of claim 10, wherein the control circuitry is configured to transmit, using the antenna, the identification message at least once before the closed-loop charging time period during the wireless power transfer session.

12. The electronic device of claim 11, wherein messages are exchanged with the wireless power receiving device during a handshake time period before the closed-loop charging time period and wherein the control circuitry is configured to transmit, using the wireless power transfer coil, the identification message at a beginning of the handshake time period.

13. The electronic device of claim 1, wherein the wireless power signal is at a frequency of approximately 13.56 MHz.

14. An electronic device operable in proximity to a wireless power transfer system, the wireless power transfer system including a wireless power receiving device and a wireless power transmitting device configured to transmit a self-identification message during a wireless power transfer operation with the wireless power receiving device, the electronic device comprising:
an antenna;
near-field communication circuitry coupled with the antenna; and
control circuitry configured to:
receive the self-identification message;
determine whether the received self-identification message is indicative of the wireless power transmitting device as operating as a wireless power transfer device or as a near-field data communication device;
in accordance with a determination of the wireless power transmitting device operating as the near-field data communication device, perform near-field data communication with the near-field data communication device; and
in accordance with a determination of the wireless power transmitting device operating as the wireless power transfer device, forgo performing the near-field data communication with the wireless power transfer device.

15. The electronic device of claim 14, wherein the control circuitry is configured to forgo performing the near-field data communication by reducing power supplied to the near-field communication circuitry.

16. The electronic device of claim 14 further comprising:
a display, wherein the control circuitry is configured to forgo performing the near-field data communication by deactivating a user interface indicative of near-field data communication for an application.

17. The electronic device of claim 16, wherein the application comprises a mobile payment application.

18. The electronic device of claim 14, wherein the wireless power receiving device comprises an accessory for the wireless power transmitting device and mountable to the wireless power transmitting device.

19. One or more non-transitory computer-readable storage media comprising computer-executable instructions that, when executed by one or more processors of a wireless power transmitting device that performs a wireless power transfer operation with a wireless power receiving device, cause the one or more processors to:
transmit, during the power transfer session, a wireless power signal to the wireless power receiving device using a wireless power transfer coil in the wireless power transmitting device; and
periodically transmit, during the power transfer session, a self-identification message that indicates a wireless power transmitting function of the wireless power transmitting device.

20. The one or more non-transitory computer-readable storage media of claim 19, wherein the wireless power transmitting device comprises a tablet computer and wherein the wireless power receiving device comprises a computer stylus.
